(19) United States
(12) Patent Application Publication
(10) Pub. No.: US 2016/0027141 A1
(43) Pub. Date: Jan. 28, 2016

(54) IN-BAND LATENCY DETECTION SYSTEM

(71) Applicant: Oculus VR, LLC, Menlo Park, CA (US)

(72) Inventors: Nirav Patel, Newport Beach, CA (US); Lee Cooper, Lake Forest, CA (US); Volga Aksoy, Irvine, CA (US)

(21) Appl. No.: 14/338,284

(22) Filed: Jul. 22, 2014

(51) Int. Cl. G06T 1/20

(52) U.S. Cl. CPC G06T 1/20

(57) ABSTRACT

There is disclosed an in-band latency detection system and method. The system comprises a motion sensor to detect movement and to generate motion data in response to the detected movement and a microcontroller programmed with instructions to apply a first time-stamp to the motion data. Upon receipt of rendered video including a preselected color, a color sensor for detects the preselected color of the at least one pixel and the microcontroller applies a second time-stamp to the detection of the preselected color to thereby calculate a time difference between the first time-stamp and the second time-stamp. The system further includes an output for outputting the time difference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to in-band latency detection.

2. Description of the Related Art

Latency is a serious problem for virtual reality systems. In games generally, delay in computer reaction to user input is bad. For example, in game worlds, a slower, less-responsive computer can lead to poor player performance while playing games. In serious cases, it leads to a drastically less-enjoyable game experience. If the environment of the game reacts slowly or is non-responsive to user input, users become disengaged or may give up playing a particular game.

Typically, systems and methods have addressed this issue in traditional desktop gaming by measuring frames-per-second (FPS). FPS is a measure of the number of rendered “frames” of video that are processed by a processor, typically, a Graphics Processing Unit (a “GPU”), and sent to a screen for display. Each “frame” is an update (either complete or partial) to the image displayed on the display. A FPS of 60 or above is often considered optimal. At this FPS, the images shown on a display are typically presented quickly enough that a user's eye does not perceive any inherent non-responsiveness.

In virtual reality systems, FPS is an important metric, but is an incomplete measure of performance because there are many more variables involved in the virtual reality process. Because FPS only measures a computer's video rendering speed, it is not always a good measure of the responsiveness of an overall system to new motion data, received from a user, in a virtual reality environment. It is, at best, an incomplete picture of the overall responsiveness of the virtual reality experience to a user. The addition of motion and position detection, transmission of those instructions to a computer, application of any motion data processing (such as motion smoothing or prediction), translation of that motion data into instructions for rendering the associated virtual environment, and the process of generating that environment for the user are distinct from FPS.

In addition, when a virtual reality headset introduces additional latency, the results are more problematic than in the traditional desktop virtual environment. Latency is perceived by the brain in a virtual environment, at best, as misaligned with expectations and, at worst, disorienting and potentially nauseating or dizzying. If latency exists in the presentation of a virtual reality environment responsive to user-generated head motion and position data, the presented virtual reality environment appears to “drag” behind a user's actual motion or may become choppy or non-responsive to user movement. This creates an incongruity between the brain's perception of reality and the virtual reality environment being presented. This incongruity is most acute as to a user's balance perception and head orientation. When this incongruity exists, a user can experience headaches, eye strain, dizziness and nausea. All of these experiences reduce user enjoyment of a virtual reality experience.

### DESCRIPTION OF THE DRAWINGS

FIG. 1 is a block diagram of an in-band latency detection system.

FIG. 2 is a block diagram of a computing device.

FIG. 3 is a functional diagram of an in-band latency detection system.

FIG. 4 is a flowchart of in-band latency detection.

FIG. 5 is a flowchart of updating a motion prediction based upon in-band latency detected.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Before the problem of latency in virtual environments can even be addressed, the measurement and sources of latency must first be determined. Latency is introduced in various stages of the virtual reality process. These stages include motion and position detection, motion and position data transmission, environmental calculation, scene rendering, transmission to the display, and the display process. Specifically, motion detection sensors must periodically sample to obtain current information, the microcontroller responsible for the sensors must read the sensors, and the microcontroller must then transmit the sensor data over an input/output interface to a computer.

Next, the computer must receive and process the sensor data and route that sensor data to a waiting application or application library that updates the current sensor state. Next, the virtual reality environment application (e.g. a virtual reality game) must request the current sensor state and then render the next video frame. At the next vertical synchronization time, the rendered frame buffer must be swapped, then one or more frames are queued in a buffer (e.g. the GPU buffer) which then is used to scan the rendered frame over the display interface for display. Finally, the display scans out the pixels and the pixels electronically switch on the display.

At each of these points one or more milliseconds of latency are added to the responsiveness of the virtual reality system. In particular, the sensor fusion, frame buffer swap, rendering, GPU scanning, and pixel electronic switching can add significant latency. Latency of more than 40 milliseconds can generally be perceived by a human use experiencing a virtual reality environment. In order to combat latency, a system for measuring overall latency in a virtual reality system is needed.

Description of Apparatus

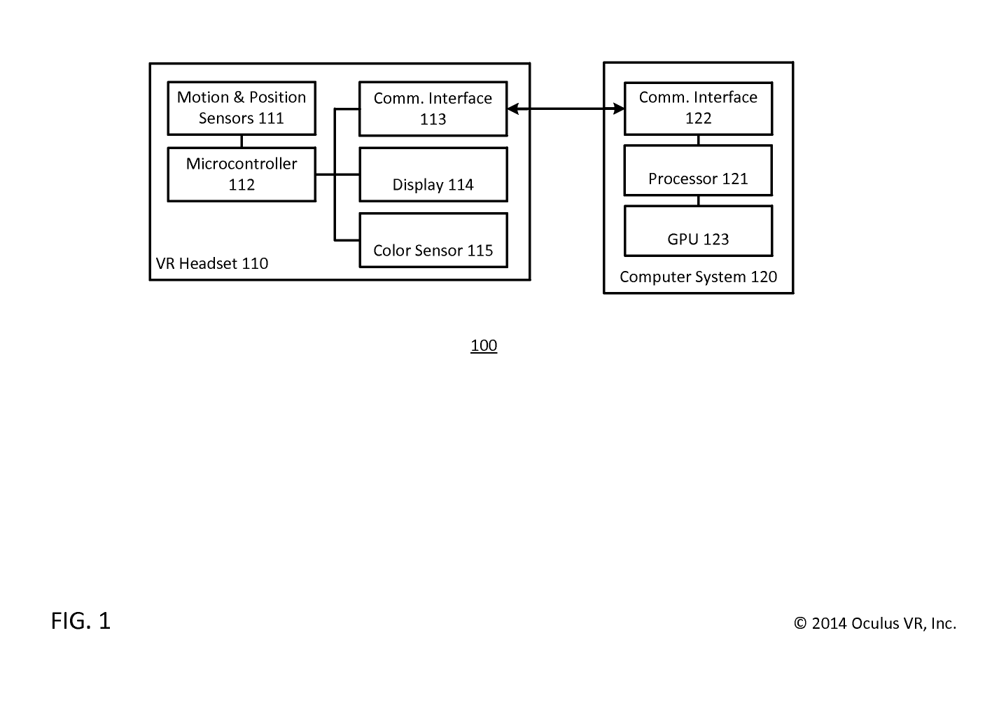

Referring now to FIG. 1, there is shown an in-band latency detection system 100. The system 100 includes a VR headset 110 and a computer system 120. The VR headset 110 is a virtual reality device that is suitable for use on a user's head. The VR headset 110 includes motion and position sensors 111, a microcontroller 112, a communications interface 113, a display 114 and a color sensor 115. The computer system 120 includes a processor 121, a communications interface 122 and a GPU (Graphical Processing Unit) 123.

The motion and position sensors 111 can be a single sensor, such as a gyroscope or can be a plurality of sensors such as a magnetometer, gyroscope, accelerometer, and/or a camera or color sensor that detects external objects or objects mounted on the VR headset 110 as a user's head moves wearing the VR headset 110. For example, an external camera may be used in connection with a series of passive or active markers mounted on a headset or a camera built into a VR headset 110 may detect head motion based upon a series of passive or active markers in the environment (e.g. affixed to walls, a computer, a series of stands, or otherwise stationary within the external environment). Other sensors may also be incorporated.

The motion and position sensors 111 generate “motion data” that may be used to control software implementing a virtual reality environment that is displayed to a wearer of the VR headset 110. The “motion data,” as used herein, includes orientation data indicating an orientation of a wearer's head and movement data indicating any movement of the wearer's head, the velocity of that movement, and the change in velocity of movement. Orientation and movement data are generated, at least in part, by motion and position sensors 111.

The “motion data” may also include positional data for the user's head, relative to the virtual reality three-dimensional space. Positional data differs from motion data because it is derived from head position relative to external points, not movement detection based upon sensors internal to a virtual reality headset. Positional data is data indicating the position of a virtual reality headset relative to external reference points. Positional data may indicate that a wearer has leaned or moved forward, leaned or moved backward, cocked a head to one side or turned a head. This positional data may be used, in addition to motion data, to more accurately track user movement. This positional data may be used to update an avatar in a virtual reality three-dimensional space, for example, if the wearer of the VR headset 110 “ducks,” the virtual reality environment may adjust to show that “duck.” This positional data may be generated by one or more motion and position sensors 111, such as an external camera.

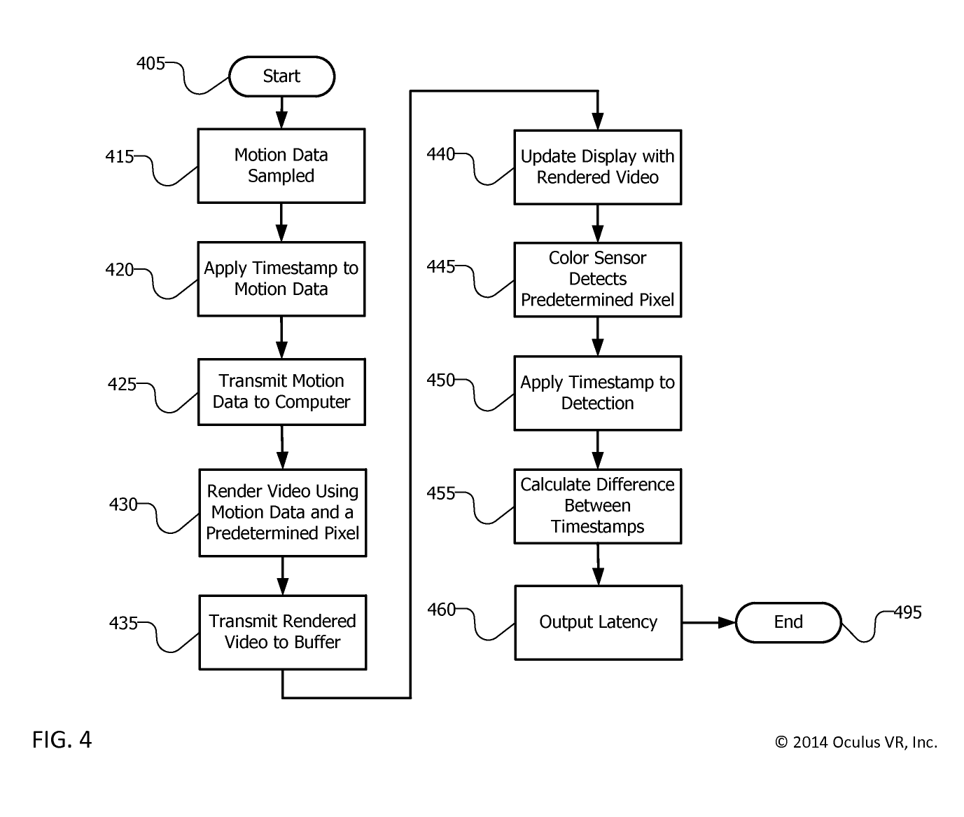

As discussed more fully below, “motion data” may further include latency data generated by the virtual reality latency detection system described herein. This “latency data” is data that indicates a prediction, based upon past actual data, of the total time from when movement data is generated by the VR headset 110 until that movement data is reflected on the display 114 of the VR headset 110. The process for generating latency data is discussed with respect to FIG. 4 below.

The phrase “virtual reality environment” as used herein means the virtual three-dimensional world presented to a wearer of the VR headset 110. In many cases, this will be a world presented on the display 114 of the VR headset 110 by computer game software. In other cases, the “virtual reality environment” may merely be a three-dimensional world or environment presented to a wearer of the VR headset 110.

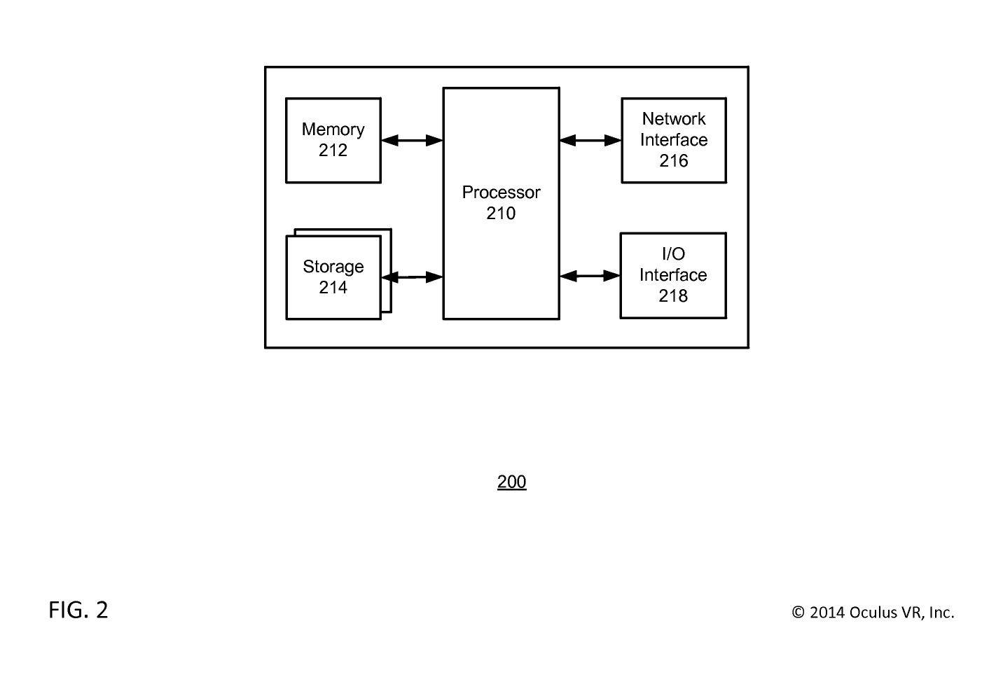

The microcontroller 112 may be a processor, cache, associated random access memory and firmware for enabling the operation of the components of the VR headset 110. The microcontroller 112 may be considered a computing device as described with reference to FIG. 2.

The communications interface 113 enables input and output to external systems, like the computer system 120. The communications interface 113 may be a single communications channel, such as HDMI, USB, VGA, DVI, or DisplayPort. The communications interface 113 may involve several distinct communications channels operating together or independently. The communications interface 113 may be or include wireless connections. For example, the communications interface 113 may utilize a USB connection for transmitting motion data and control data from the microcontroller 112 to the communications system 120, but may rely upon an HDMI connection or DVI connection for receipt of audio/visual data that is to be rendered on the display 114.

The display 114 may be a single display or multiple displays capable of rendering video for viewing by a VR headset 110 user. The display is capable of showing a plurality of pixels making up a visible image to a user and capable of updating with sufficient speed to show a moving scene to a VR headset 110 user. The display may have resolution of 1200 by 800 pixels or a so-called “HD” resolution of 1920 by 1080 pixels. Higher resolution displays (called “4K displays”) are becoming common and may be integrated into the VR headset 110 as the display 114. Still higher resolutions are possible in the future. The display 114 may, in fact, be multiple displays. However, some benefits, such as automatic synchronization of two images (one for each eye) shown on the display 114 is possible when a single display is utilized for virtual reality displays, like display 114. However, this has the negative consequence of halving the horizontal resolution available for each eye.

The color sensor 115 may be integrated into the VR headset 110. The color sensor 115 is capable of detecting a specific color pixel in an image made up of thousands or millions of pixels. The color sensor 115 is controlled by the microcontroller 112 to search for and identify a specific, known color when so-instructed. The color sensor 115 employed is of sufficient fidelity to detect a certain color pixel, several pixels or pixels arranged in a predetermined shape or orientation within a display, such as display 114.

Alternatively, and although shown as a separate component for purposes of description, the color sensor 115 may be incorporated as a part of one or more integrated circuits making up a part of the VR headset 110. For example, the color sensor 115 may be a part of an integrated circuit used to drive the display 114 or a part of the microcontroller 112 or other integrated controller used in conjunction with the display 114. In such cases, the color sensor 115 may have direct access to incoming video frames prior to or substantially simultaneously with their physical display on the display 114. The color sensor 115, in such cases, may read that incoming frame data in order to detect a certain color pixel, several pixels or pixels arranged in a predetermined shape or orientation within a frame of video, as described above relative to the display 114. In this way, the color sensor 115 may operate at a software level without physically detecting color changes visible on the display 114.

The processor 121 of computer system 120 may be a general purpose processor including cache and having instructions, for example, an operating system and associated drivers, for interfacing with the VR headset 110.

The communications interface 122 may be, as described above, an input and output interface for communicating with the VR headset 110. The communications interface 122 may be or include USB, HDMI, DVI, VGA, DisplayPort and other communications interfaces. The communications interface 122 may be or include wireless connections such as Bluetooth, 802.11 wireless connections, short range radio frequency connections and other, similar wireless connections. The communications interface 122 may enable both input and output.

The communications interface 122 enables the VR headset 110 to communicate data, such as motion data, control data, and color sensor information to the computer system 120. The communications interface 122 also enables the computer system 120 to communicate control data and driver instructions, along with rendered video data to the VR headset 110. For example, instructions may be transmitted back and forth across a USB connection between the VR headset 110 and the computer system 120, while audio/video data is provided to the VR headset 110 display 114 via an HDMI connection. Many other options are possible for providing all or a part of the communications interface 122.

The GPU (Graphics Processing Unit) 123 receives instructions from the processor 121 and renders three-dimensional images that correspond to those instructions. Specifically, virtual environment software programs (such as an interactive computer game) provide instructions to the processor 121 and the GPU 123 that are then converted by the processor 121 and GPU 123 into virtual reality environments that are shown on the display 114.

Turning now to FIG. 2 there is shown a block diagram of a computing device 200, which is representative of the VR headset 110 and the computer system 120 in FIG. 1. The computing device 200 may be, for example, an integrated system-on-a-chip, a microcontroller, a desktop or laptop computer, a server computer, a tablet, a smart phone or other mobile device. The computing device 200 may include software and/or hardware for providing functionality and features described herein. The computing device 200 may therefore include one or more of: memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor 210 may be or include one or more microprocessors or application specific integrated circuits (ASICs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 214 and does not include transitory media such as signals or waveforms. In some cases, such as those involving solid state memory devices, the memory 212 and storage 214 may be a single device.

The network interface 216 includes an interface to a network. The network interface 216 may be wired or wireless.

The I/O interface 218 interfaces the processor 210 to peripherals (not shown) such as, for example and depending upon the computing device 200, sensors, displays, cameras, color sensors, microphones, keyboards and USB devices.

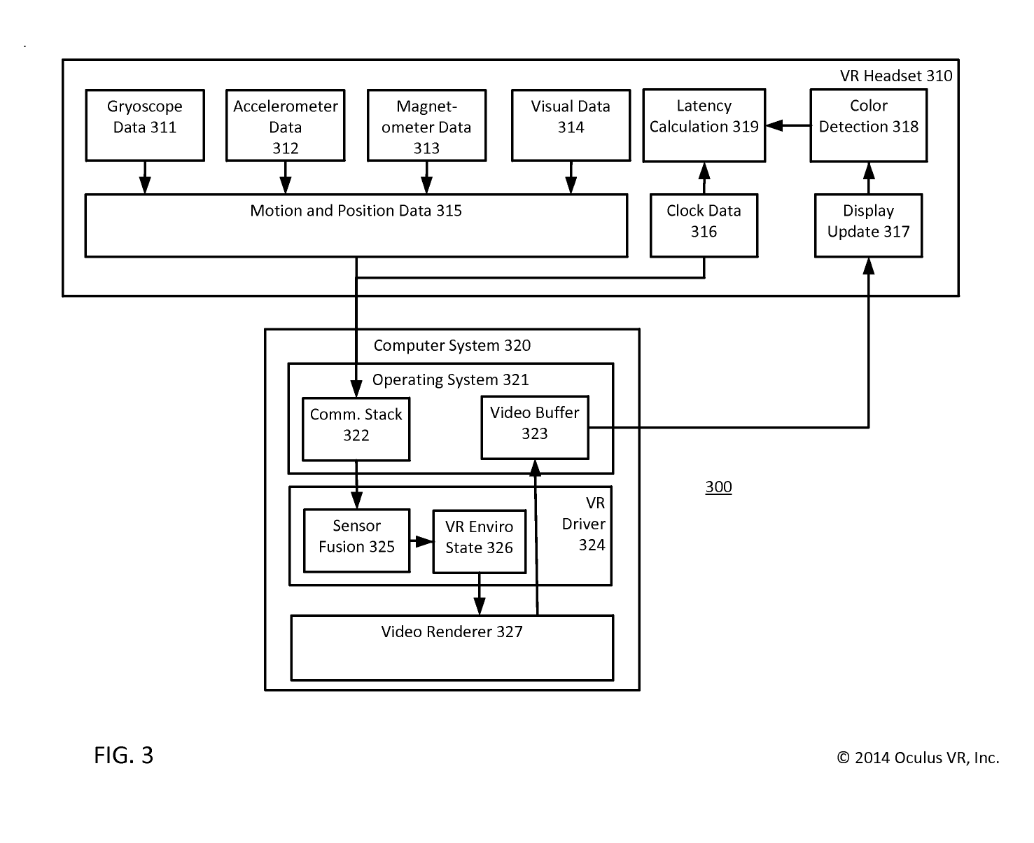

Turning now to FIG. 3 there is shown a functional diagram of an in-band latency detection system 300. This FIG. 3 is distinct from the block diagram of FIG. 1 in that this figure discloses the functional elements that make up the system, as opposed to the physical components. The system 300 includes the same VR headset 310 and computer system 320 of FIG. 1. Although shown distinct from one another, the VR headset 310 and computer system 320 may, in some situations, be one and the same.

The VR headset 310 generates gyroscope data 311, accelerometer data 312, magnetometer data 313, and visual data 314 that is combined into motion and position data 315 before transmission to the communication stack 322 (such as a USB stack) of the computer system 320 along with clock data 316 including a first timestamp associated with when the motion and position data 315 was generated.

The computer system 320 receives the motion and position data 315 through the communications stack 322 and passes it to a sensor fusion process 325 within the virtual reality driver 324. The resulting output of sensor fusion 325 describes the pitch, yaw, roll, orientation, spatial location, velocity, and change in velocity of the VR headset 310 at the given sample time. The sensor fusion process 325 may also perform motion prediction or smoothing based upon the motion and position data 315.

Th output of the sensor fusion process 325 is passed to the virtual reality environmental state engine 326. This virtual reality environmental state engine 326 may be or include, for example, computer game software or other virtual reality environment software. Further, the VR environmental state engine 326 may be, include or interact directly with the VR driver 324 to generate output conforming to input from the VR headset 310.

The VR environmental state engine 326 passes instructions according to the sensor fusion process 325 to the video renderer 327, which operates in conjunction with the processor 121 and GPU 123 of FIG. 1, to generate each frame of video for display on the display 114 of FIG. 1. Each frame of video, after rendering, is passed to the video buffer 323 for output to the VR headset 310. The VR headset receives the new frame of data and an instruction to update the display 317. The color sensor 115 of FIG. 1 then detects the color at 318 and obtains a second timestamp. The first and second timestamps may be compared to generate a latency calculation 319.

Description of Processes

Referring now to FIG. 4, a flowchart of in-band latency detection is shown. The process begins when motion data is sampled at 415. This may be, for example, gyroscope data generated by a gyroscope that is a part of the motion and position sensors 111. This may, alternatively, be any motion data generated by some or all of the motion and position sensors 111. Motion data typically results in a need to re-generate the video being displayed on the display 114 of a VR headset 110 because the motion data typically indicates that the user has adjusted his or her view of the scene being presented, if only to a small degree. As such, motion data begins the process of re-rendering a scene that changes in response to that motion data.

As the motion and position sensors 111 data is sampled to generate motion data, a timestamp is applied at 420. This timestamp is associated with the time that the motion data was generated. The motion data timestamp may have a very high degree of accuracy, such as a millisecond or microsecond level of accuracy as to when the motion data sample was taken. The timestamp may be applied by the microcontroller 112.

Next, the motion data is transmitted to a computer system, like computer system 120 (FIG. 1) or computer system 320 (FIG. 3), at 425. The motion data may come into the computer system 320 via a communications stack 322 of the operating system 321 which handles all input into the computer system 320.

The motion data is then used by software, for example by video game software, to render a frame of video including at least one pixel of video in a predetermined color and/or shape at 430. For example, a four by four pixel square of a particular color may be requested by a software library responsible for controlling the communication with the VR headset 310. Alternatively, a single pixel or group of pixels of a predetermined shape may be inserted into the rendered frame of video for transmission to the VR headset 310.

The motion data used in rendering at 430 is used in generating the scene being rendered by the computer system 320. So, for example, as a wearer of the VR headset 310 turns his or her head, the motion data related to that head turn is transmitted to the computer at 425 and used to generate the render at 430 of the next frame of video. A library (such as a device driver) designed to interact with the VR headset 310, the motion data generated and the screen layout and three-dimensional environment systems, may be used in that rendering process to enable the rendering to occur in a manner suitable for output to the VR headset 310.

Next, the rendered video including the at least one pixel of a predetermined color and/or shape is transmitted to the video buffer at 435, typically at the next vertical sync of the display.

Then, the display is updated with the rendered video including the at least one pixel of a predetermined color and/or shape at 440. This process involves a GPU pushing one the rendered video frame from the buffer onto the display. In some cases, multiple frames may have been rendered and buffered. These rendered frames may be pushed out, each in turn, onto the display at 440, so as to create a moving scene of rendered video.

The color sensor 115 in the VR headset 110 then detects the at least one pixel of a predetermined color and/or shape at 445. This color sensor 115 may be informed, beforehand, of the color and/or shape to be looking for by virtual reality game software or a library used in rendering a virtual reality environment.

For example, the library and drivers associated with causing the VR headset 110 to function appropriately in conjunction with the computer system 120 may take on the role of selecting and informing the microcontroller 112 that operates the color sensor 115 of the at least one pixel of predetermined color and/or shape to be searched for and detected by the color sensor 115. This data may then be used by the microcontroller 112 in conjunction with the color sensor 115 to detect the exact frame of rendered video that includes the at least one pixel of predetermined color and/or shape at 445.

The detection at 445 may take place, as described above, without reference to the physical display, but with reference to underlying data in a video frame or stream of data making up a part of a rendered video frame. The stream of data may be in transit or the video frame may be, for example, in a frame buffer in anticipation of being displayed on a display.

Once the at least one predetermined pixel has been detected at 445, a timestamp is applied at 450 to that detection. The timestamp may be generated and applied to the data by the same microcontroller 112 that generated the first timestamp at 420.

The two timestamps may then be used, either by the microcontroller 112 in the VR headset 110 or the processor 121 in the computer system 120 to calculate the difference between the timestamps as latency at 455. This is the latency inherent in the system because it is the total difference between the motion data that caused an updated rendering to be generated and the rendered video incorporating that motion data (and the at least one pixel of predetermined color and/or shape) to be displayed to the wearer of the VR headset 110.

This process can occur as often as desired, even up to making a calculation for every frame of rendered video. Even in frames without movement, the lack of movement data results in a new render of the same scene (things on the display may still move relative to the user). Thus, a large number of actual calculations (as opposed to estimates), end-to-end for every frame of rendered video may be created without any significant impact on the overall system. Indeed, the calculations may be made while the system is operating under normal conditions.

The latency may then be output at 460. This output may be only to a driver, library or virtual reality software that is generating the associated virtual reality environment. The latency output at 460 may, be output to the driver, library, or virtual reality software to enable one or more of them to alter the game or other variables associated with rendering going forward and to better-render the virtual reality environment.

For example, if a high latency is detected, the rendered video scene may be simplified in real time to rely upon less shading, fewer light sources, to reduce shadows or shadow depth, to lower polygon counts, to increase motion prediction or to otherwise perform functions designed to lower the overall latency and increase the performance of the virtual reality environment. This simplification may enable the hardware and software responsible for creating a virtual reality environment to immediately recover, providing a much more responsive (less-latency) environment for a VR headset wearer.

Similarly, builds of virtual reality environment software may be updated in view of these latency measurements to improve overall latency. The latency calculations may be used to pinpoint virtual reality environment aspects that should be altered, optimized or otherwise improved so as to reduce the overall latency and provide a smoother, better experience for a VR headset wearer. Alternatively or in addition, an indication of the latency may be output or be displayed on the display 114 or on a display (not shown) associated with the computer system 120 (FIG. 1).

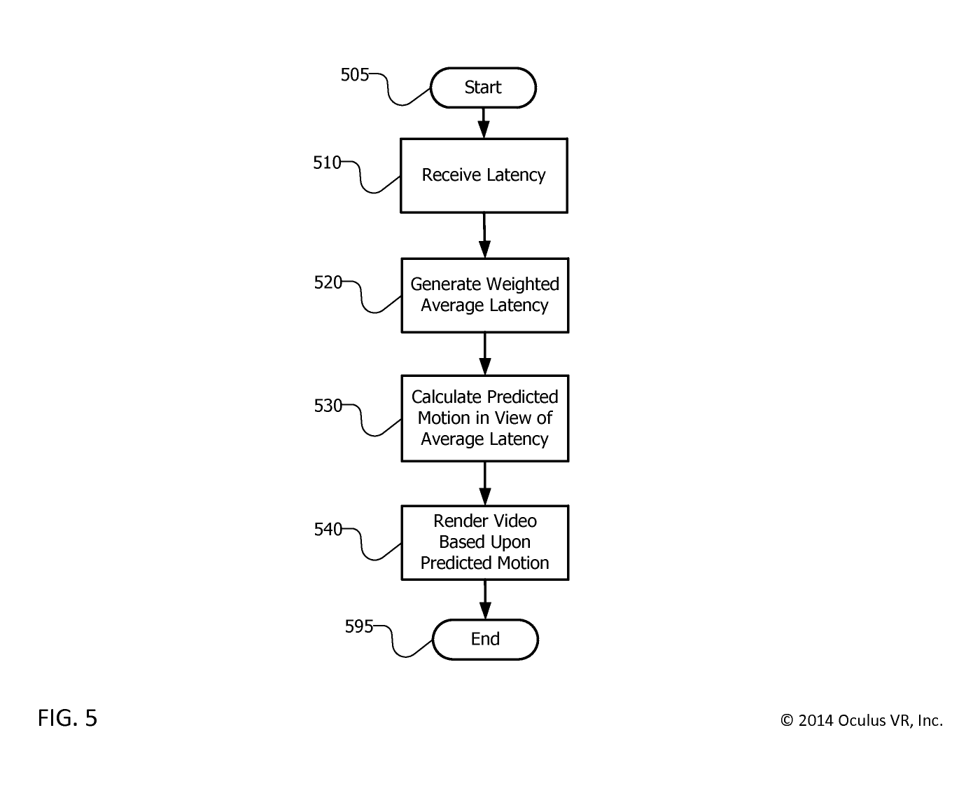

Turning now to FIG. 5, a flowchart of updating a motion prediction based upon in-band latency detected is shown. In response to latency output at 460, motion prediction associated with a virtual reality experience can be refined. Specifically, motion prediction that makes attempts to estimate the orientation of a virtual reality headset wearers head at a predetermined interval in the future (e.g. 40 milliseconds into the future) can be updated to incorporate latency data to account for delay in the video rendering process.

First, the system must receive the latency at 510 that is output at 460. This “receipt” may be no more than accessing a memory location that contains data pertaining to the most recent latency calculation. Alternatively, receipt at 510 may require accessing data stored on the VR headset 110.

Next, the system may generate a weighted average latency for the overall system at 520. A table setting forth a series of example latencies received for a virtual reality headset is set forth below.

TABLE 1

| Time (t) (in | Latency (in |
|---|---|
| seconds) | milliseconds) |
| t-5.0 | 100 |
| t-4.5 | 60 |
| t-4.0 | 150 |
| t-3.5 | 120 |
| t-3.0 | 100 |
| t-2.5 | 100 |
| t-2.0 | 50 |
| t-1.5 | 75 |
| t-1.0 | 60 |
| t-0.5 | 50 |

As can be seen from TABLE 1, latency over the example time period of t−5.0 to t−0.5 varies from 50 milliseconds to 150 milliseconds. The latencies shown, the time periods chosen, and the associated sample periods of 0.5 seconds are merely for purposes of presenting an example. Different sample periods and different latencies may be common. In fact, tiny sample periods on the order of milliseconds or microseconds may be used and real-world latencies are typically much smaller than those shown.

A simple average of these latencies in TABLE 1 is 865 (the total latency)/10 (the number of samples), or 86.5 milliseconds. A weighted average may alter this by emphasizing the most recent samples or by emphasizing the most delayed samples. For example, a weighted average that provides no weight to samples more than 2 seconds ago, would only consider the three samples at 75 milliseconds, 60 milliseconds and 50 milliseconds from t−1.5 on. The weighted average of these samples would be 185 (total of these three samples)/3 (total samples)=61.6−a much lower weighted average latency than that of the entire sample period.

A more complex latency model appears below.

TABLE 2

| Time (t) (in | Latency (in | | Weighted |
|---|---|---|---|
| seconds) | milliseconds) | % Weight | Scores |
| t-5.0 | 100 | 0% | 0 |
| t-4.5 | 60 | 0% | 0 |
| t-4.0 | 150 | 5% | 7.5 |
| t-3.5 | 120 | 5% | 6 |
| t-3.0 | 100 | 10% | 10 |
| t-2.5 | 100 | 10% | 10 |
| t-2.0 | 50 | 10% | 5 |
| t-1.5 | 75 | 20% | 15 |
| t-1.0 | 60 | 20% | 12 |
| t-0.5 | 50 | 20% | 10 |
| | | Weighted | 75.5 |
| | | Average | |

The weights applied are shown in the third column of Table 2. This weighting is a simple model in which the overall weight is in a set model. In this model, the most recent three sample periods are applied a weighting of 20%, whereas the next three are applied a 10% weighting and the next two are applied at 5% weighting and the last three are applied no weighting. In other implementations, the weighting applied may follow a simple formula, an exponentially decaying formula or other system that is shown to correlate with the best latency compensation as applied to predictive motion systems.

Here, each of the latencies are multiplied by their weighting, then they are summed to determine the weighted average. Here that average is 75.5 milliseconds. All of the weighting, weighted averages, and latencies are merely examples. Larger or smaller numbers may be typical of a given virtual reality system.

Once the weighted average of the latency is generated at 520, predicted motion (and associated predicted orientation/location) may be calculated in view of the weighted average latency at 530. Specifically, if a user's location in a system in which there is zero latency is predicted to be coordinates of (x, y, z) and oriented such that a user is facing coordinate (x′,y′,z′) at d distance and at time t, but there is a weighted average latency of 75.5 milliseconds, as set forth above, then the algorithm applied to generate the predicted motion, position, and orientation may be updated to generate, instead, the motion, position, and orientation at the time t+75.5 ms in order to account for the weighted average of the latency. This prediction will be likely to be more closely aligned with the user's actual motion, position, and orientation at that time in the future.

Alternatively, a developer or associated, automated software reviewing data may look for “spikes” of increased latency (relative to average latency or a weighted average latency) in order to identify problem areas in a virtual reality environment or an overall virtual reality experience. An automated system may, for example, maintain a running average of data and flag latency measurements that fall outside of a threshold (e.g. more than 20 milliseconds larger than an average latency) as a “spike” that may require further investigation. A table exemplifying this scenario is shown below.

TABLE 3

| Time (t) (in | Latency (in |
|---|---|
| seconds) | milliseconds) |
| t-5.0 | 35 |
| t-4.5 | 41 |
| t-4.0 | 49 |
| t-3.5 | 152 |
| t-3.0 | 64 |
| t-2.5 | 30 |
| t-2.0 | 29 |
| t-1.5 | 41 |
| t-1.0 | 48 |
| t-0.5 | 43 |

Here in this table, the latency at time t−5.0 to time t−4.0 averages about 45 milliseconds. The average latency from time t−3.0 to time t−0.5 is about 40 milliseconds. However, there is a noticeable “spike” in latency of 152 milliseconds at time t−3.5. This “spike” may be due to a particularly complex portion of a virtual environment including many dynamic light sources or may be a time when the VR headset wearer turned his or her head past a model with a particularly high polygon count. It may, alternatively, indicate that the user turned his or her head in such a way that the system was unable to quickly determine the associated movement. As a result, whatever the reason, the latency increased dramatically at that time.

Regardless of the reason, using very precisely-timed data, a developer of a virtual reality environment can identify these locations or times in the virtual reality environment. Once they are identified, these locations or times can be modified to remove or better-optimize the virtual reality environment in order to eliminate latency spikes. Alternatively, virtual reality environment software may automatically identify these locations and adjust the rendering characteristics in order to decrease latency.

Finally, the video may be rendered taking into account the weighted average latency at 540.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. An in-band latency detection system comprising:
a motion sensor to detect movement and to generate motion data in response to the detected movement;
a microcontroller programmed with instructions to apply a first time-stamp to the motion data, transmit the motion data to a computing device for rendering video based upon the motion data for presentation on a display,
an input for receiving rendered video based upon the motion data and including at least one pixel of a preselected color, the at least one pixel distinct from the scene presented by the rendered video, for presentation on the display;
the display for presenting the rendered video;
a color sensor for detecting the preselected color of the at least one pixel;
the microcontroller further programmed with instructions to:
predict a motion of a user over an interval of time;
apply a second time-stamp to the detection of the preselected color,
calculate a time difference between the first time-stamp and the second time-stamp the time difference representative of a latency between the detected movement and presentation of the rendered video,
access a prior time difference associated with a previously received rendered video, the prior time difference representative of a latency between previous detected movement and previous presentation of associated rendered video,
apply a first weight to the time difference,
apply a second weight to the prior time difference, where the second weight is less than the first weight, and
generate a weighted average of the time difference and the prior time difference; and
in response to the weighted average exceeding a threshold, increasing the interval of time over which the user's movement is predicted.

2. The system of claim 1 further comprising at least one processor programmed with instructions to:
generate the rendered video based upon the motion data; and
set the least one pixel in the rendered video to the predetermined color.

3-4. (canceled)

5. The system of claim 1, wherein the predicted motion is refined by applying the weighted average to the predicted motion.

6. The system of claim 5, wherein the rendered video is updated based upon the refined predicted motion.

7. The system of claim 1, wherein the at least one pixel is a plurality of pixels that makes up a shape detectable by the color sensor in the rendered video.

8. An in-band latency detection method comprising:
detecting movement;
generating motion data in response to the detected movement;
predict a motion of a user over an interval of time applying a first time-stamp to the motion data;
transmitting the motion data to a computing device for rendering video based upon the motion data for presentation on a display,
receiving rendered video based upon the motion data and including at least one pixel of a preselected color, the at least one pixel distinct from the scene presented by the rendered video, for presentation on the display;
presenting the rendered video on the display;
detecting the preselected color of the at least one pixel;
applying a second time-stamp to the detection of the preselected color,
calculating a time difference between the first time-stamp and the second time-stamp, the time difference representative of a latency between the detected movement and presentation of the rendered video;
accessing a prior time difference associated with a previously received rendered video, the prior time difference representative of a latency between previous detected movement and previous presentation of associated rendered video;
applying a first weight to the time difference;
applying a second weight to the prior time difference, where the second weight is less than the first weight;
generating a weighted average of the time difference and the prior time difference; and
in response to the weighted average exceeding a threshold, increasing the interval of time over which the user's movement is predicted.

9. The method of claim 8, further comprising:
generating the rendered video based upon the motion data; and
setting the least one pixel in the rendered video to the predetermined color.

10-11. (canceled)

12. The method of claim 8, further comprising refining the predicted motion by applying the weighted average to the predicted motion.

13. The method of claim 12, wherein the rendered video is updated based upon the refined predicted motion.

14. The method of claim 8, wherein the at least one pixel is a plurality of pixels that makes up a shape detectable by the color sensor in the rendered video.

15. A system for detecting latency in presenting a virtual reality environment, comprising:
a motion sensor for detecting movement and generating motion data in response to the movement;
a microcontroller for applying a first time-stamp to the motion data;
an output for transmitting the motion data to a computing device for use in connection with rendering a virtual reality environment in response to the motion data;
an input for receiving rendered video of the virtual reality environment, the rendered video generated in response to the motion data and including at least one pixel set to a predetermined color, the predetermined color selected to enable detection of the at least one pixel, within the rendered video, by a color sensor;
the color sensor for detecting the at least one pixel; and
the microcontroller further for:
predict a motion of a user over an interval of time;
applying a second time-stamp to detection of the at least one pixel,
generating a latency measurement by comparing the first time-stamp and the second time-stamp, the latency measurement representative of a latency between the detected movement and presentation of the rendered video,
accessing a prior latency measurement associated with a previously received rendered video, the prior latency measurement representative of a latency between previous detected movement and previous presentation of associated rendered video,
applying a first weight to the latency measurement,
applying a second weight to the prior latency measurement, where the second weight is less than the first weight, and
in response to the weighted average exceeding a threshold, increasing the interval of time over which a user's movement is predicted.

16. The system of claim 15, wherein the output is further for outputting the weighted average.

17-18. (canceled)

19. The system of claim 15, wherein the rendered video is updated based upon the predicted motion as refined by the weighted average.

20. The system of claim 15, wherein the at least one pixel is a plurality of pixels that make up a shape detectable by the color sensor in the rendered video.

21. The system of claim 1, further comprising at least one processor programmed with instructions to:
access a threshold time difference;
determine whether the time difference exceeds the threshold time difference; and
responsive to determining the time difference exceeds the threshold time difference, mark the time difference for review.

22. The system of claim 1, wherein the computing device is configured to modify the rendering of a video scene based on the weighted average.

23. The system of claim 1, wherein the computing device is configured to:
determine whether the weighted average indicates high latency; and
responsive to determining the weighted average indicates high latency, simplify the rendering of a scene in the video to perform one or more functions, the one or more functions selected from a group consisting of: rely upon less shading, rely upon fewer light sources, reduce shadows, reduce shadow depth, lower polygon counts, increase motion prediction, and any combination thereof.

24. The system of claim 1, wherein the computing device is configured to modify one or more aspects of a virtual reality environment including the rendered video.

25. The system of claim 1, wherein the predicted motion comprises a set of coordinates of the user's orientation at the time of the weighted average.
